(19) United States
(12) Patent Application Publication
(10) Pub. No.: US 2020/0356519 A1
(43) Pub. Date: Nov. 12, 2020

(54) TECHNIQUES FOR SERIAL COMMUNICATION

(71) Applicants: Wayne Ballantyne, Chandler, AZ (US); Gunnar Bublitz, Heroldsberg (DE); Jinghui Lu, Austin, TX (US)

(72) Inventors: Wayne Ballantyne, Chandler, AZ (US); Gunnar Bublitz, Heroldsberg (DE); Jinghui Lu, Austin, TX (US)

(21) Appl. No.: 16/766,888

(22) PCT Filed: Mar. 29, 2018
(86) PCT No.: PCT/US2018/025242

§ 371 Date: May 26, 2020

(51) Int. Cl. G06F 13/42

(52) U.S. Cl. CPC G06F 13/4282

(57) ABSTRACT

Techniques are provided for improving serial communications, especially time-sensitive serial communications. Such techniques can include a method comprising: receiving information via an input serial communication port of a control circuit, the input serial communication port having at least two conductors; in a serial mode of the control circuit, buffering the information as the information is received, parsing the information according to a serial protocol, and processing the information according to the serial protocol; and in a binary mode of the control circuit, conforming an operation of the control circuit in response to a state of at least one of the two conductors.

### TECHNICAL FIELD

This document pertains generally, but not by way of limitation, to serial communications, and more particularly to protocol interruption and balancing techniques to improve communication throughput.

### BACKGROUND

Electronic circuits evolution continues to provide ever increasing functionality and speed from ever smaller systems. Such miniaturization pressures circuit designers to use less components, such as circuit terminals, vet provide improved performance. Serial communication of data between components can often provide a superior solution compared to parallel communication because of the reduced number of conductors. However, in order to match the data throughput of a parallel communication bus, serial communication clock rates are substantially higher than a clock rate of a.

corresponding parallel communication system. As serial clock rates increase, the system can require more sophistication as margins of error for detecting each bit of serial data becomes smaller and smaller. Improvements to transfer data with less clock cycles or less overhead are desired.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates generally an example circuit configured to communicate using a serial bus according to various aspects of the present subject matter.

FIG. 2 illustrates generally a plot of signals associated with executing a simple command in binary mode as discussed above.

FIG. 3 illustrates generally a flowchart of an example method 300 of operating a serial communication system with a binary mode.

FIG. 4 illustrates generally an example circuit employing a line code controller according various aspect of the present subject matter.

FIG. 5A illustrates generally an example data frame of information to be transmitted by a physical interface circuit according to various aspects of the present subject matter.

FIG. 5B illustrates generally a flowchart of an example method associated with processing the data frame of FIG. 5A according to various aspects of the present subject matter.

FIG. 6 illustrates generally a flowchart of an example method of controlling a serial communication interface to reduce line coding overhead.

FIG. 7 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines.

FIG. 8 illustrates a system level diagram, depicting an example of an electronic device (e.g., system) that can employ serial communication improvements as described in the present disclosure.

FIG. 9 illustrates an exemplary base station or infrastructure equipment radio head according to some aspects of the present subject matter.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

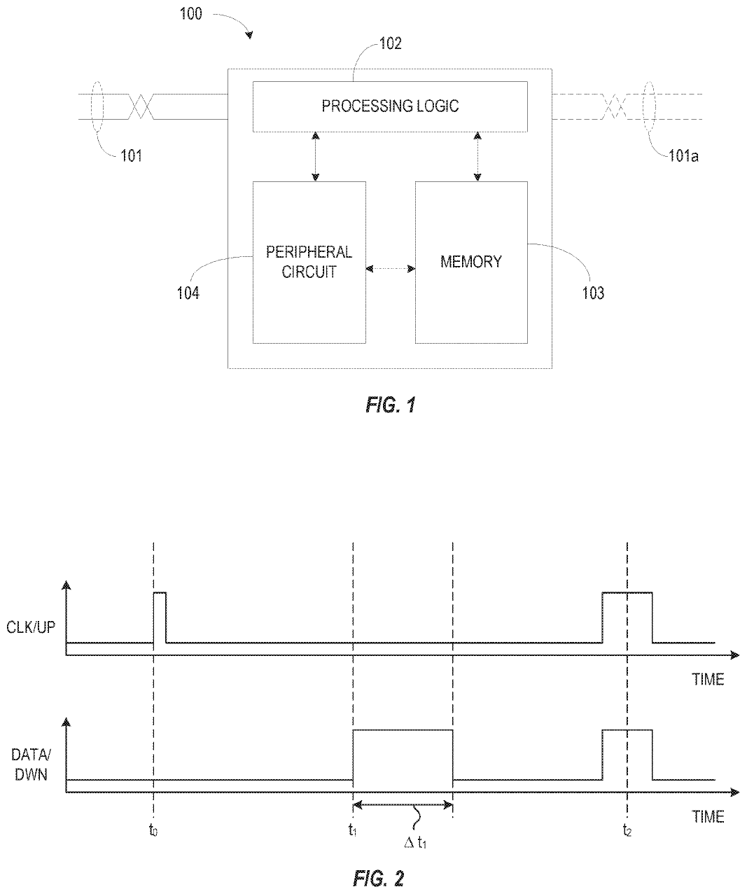

FIG. 1 illustrates generally an example circuit 100 configured to communicate using a serial bus 101 according to various aspects of the present subject matter. Serial communications are illustrated as being conducted on only two wires, however, other numbers of wires can be employed for the serial communications without departing from the present subject matter. The circuit 100 can include processing logic 102, memory 103, and one or more peripheral circuits 104 including at least one peripheral circuit responsive to a binary command. In certain aspects, in a serial mode of operation, the processing logic 102 can exchange information with other devices using the serial bus 101 and a serial communication protocol. Such protocols can include but are not limited to, Serial Peripheral Interface (SPI), Inter-integrated circuit (I2C), Mobile Industry Processor Interface (MIDI) Radio Frequency Front-end Interface (RIFE), etc. In some examples, a serial port of the processing logic 102 can couple to the serial bus 101 as node or in parallel with other device ports on the serial bus 101. In some aspects, the processing logic 102 can be a node on a daisy chain type of serial bus 101 and can optionally pass serial communication through to other devices on a continuation of the serial bus 101a.

In certain examples, the processing logic 102 can receive a command that instructs the processing logic 102 to enter a binary mode of operation and to treat one or more of the conductors of the serial bus 101 as binary command signals. In binary mode, delay in changing a state of, for example, a peripheral device of the peripheral circuit 104 can be greatly reduced compared to receiving, buffering and decoding a serial command to change the peripheral device.

With regards to the example circuit of FIG. 1, the serial bus 101 can include two conductors. In an aspect, while being used as a serial bus, one conductor can carry a clock signal and the other conductor can carry a data signal. Such use of a two-wire serial bus is characteristic of, for example, an PC type of serial protocol often used for communication between integrated circuits of a device such as a smartphone. In various aspects, the processing circuit can receive a command via the serial bus to treat the two conductors of the serial bus as binary signals. Upon receiving such a command, the processor passes the state of the two serial conductors to a peripheral circuit where a pulse on one conductor causes a first action, and a pulse on the other conductor causes a second action. In some aspects, the periphery circuit can include, but is not limited to an actuator, a counter, a timer, a voltage regulator, etc., and the actions can change a state of the periphery circuit. For example, where the periphery circuit includes an actuator, a state of actuator can be responsive to a state of one of the conductors. Such an implementation can eliminate processing delay of parsing a corresponding serial command configured to command a state of the actuator.

As other examples, the periphery circuit can include a counter or a parameter. In such examples, a first action can include incrementing the counter or parameter, and the second action can include decrementing the counter or parameter. In another aspect, the width of each pulse can determine an increment or decrement amount. In such examples, the first action can increase counter or parameter by an amount determined by the width of the pulse on the first conductor, and the second action can decrease the counter or parameter by an amount determined by the width of the pulse on the second conductor. It is understood that the conductors of the serial bus can be reassigned for other functions besides those discussed above. Such additional functions can include, but are not limited to, increase/decrease voltage, receiver on/off control, etc. In serial mode, simple commands to execute the above functions can take multiple clock cycles, such as 8-16 or more, to effect the desired change. For example, with a 38.4 MHz data clock, 16 clocks can consume 417 nsec. Wireless communication systems, such as 5G, where symbol times can be as low as 8.9 microseconds (μs), thus, the execution time for a single register write command is not trivial. The present subject matter allows for some commands to be executed significantly faster than those communicated using a serial protocol while also not adding additional pins.

In certain aspects, transition from the serial mode to the binary mode can be triggered using a serial command. in some aspects, the serial command can directly trigger gating logic of the processing logic to treat one or more of the conductors of the serial bus as binary control signals instead of a serial communication signal. In some aspects, a serial command can change a memory location that enables and disables the binary mode.

FIG. 2 illustrates generally a plot of signals (e.g., CLK/UP, DATA/DWN) associated with executing a simple command in binary mode as discussed above. In an aspect, during serial mode operation, a first signal carried on a. first conductor of the serial bus is a clock signal (CLK) and a second signal carried on a second conductor of the serial bus is a data signal (DATA). In binary mode, the signals on the same conductors are no longer processed as a clock signal and a data signal. In binary mode, the signals are processed as binary control signals. In the illustrated aspect, the first signal on the first conductor can be a binary “UP” control signal and the second signal on the second conductor can be a binary “DOWN” control signal. It is understood that the functional label of the binary control signals is not limiting and that other control functions can be assigned to each binary control signal as desired by the designer or the application without departing from the scope of the present subject matter.

In certain aspects, a pulse, at to, within the first signal (CLK/UP) can initiate an “UP” action in a peripheral circuit. Such peripheral circuits can include, but are not limited to, a counter, a memory location with a parameter, a voltage regulator, etc., and the “UP” action can increment the counter, the parameter, a voltage set point, etc, When a pulse is received, at 0, within the second signal (DATA/DWN), the counter, parameter or voltage set point can be decremented. The “UP” and “DOWN” action can occur with little if any delay in binary mode compared to multiple clock cycle delays if the same commands were received in serial mode. The multiple clock delays in serial mode correspond to buffering, parsing, and decoding the serial information that includes the commands.

In certain aspects, additional conductors of the serial bus can be used to select which peripheral circuit responds to the binary control signals of the first or second conductors, or which counter, parameter, voltage regulator, etc., responds to the binary control signals of the first or second conductors, In some aspects, the width of a pulse of a binary control signal can be used to control an additional aspect of the peripheral circuit. For example, with reference to the application of FIG. 2, the width of the pulse, at to, of the first signal (CLK/UP) can indicate an amount of “UP” action and the width (e.g., Δt₁) of the pulse, at t₁, of the second signal (DATA/DWN) can indicate an amount of “DOWN” action. If, for example, the peripheral circuit is a regulator and a pulse is received during binary mode on the first conductor, the peripheral circuit can increase a voltage set point by an amount set by the width of the received pulse. As discussed above, the peripheral circuit is not limited to a voltage regulator. In certain aspects, if a pulse is simultaneously received on both the first conductor and the second conductor during binary mode, such as at t₂, a third action can be initiated. In some aspects, the third action can include exiting the binary mode of operation. In such aspects, the gating logic can detect reception of the simultaneous reception of the pulses and can change transition the processing logic from the binary mode to the serial mode. In some examples, the peripheral or the gating logic can detect reception of the simultaneous reception of the pulses and can change memory location controlling the operating mode of the processing logic such that the processing logic transitions from the binary mode to the serial mode.

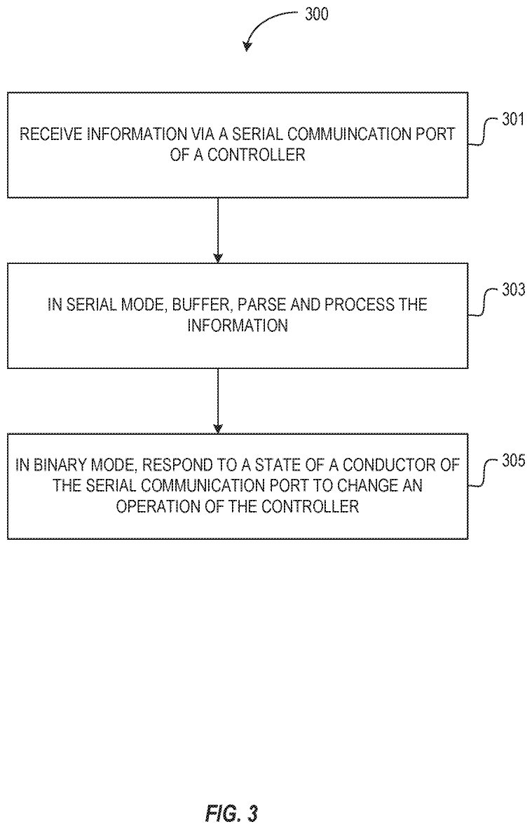

FIG. 3 illustrates generally a flowchart of an example method 300 of operating a serial communication system with a binary anode. At 301, information can be received at a serial communication port of a device or a control circuit. In certain aspects, the device may be an integrated circuit of a larger system. In some aspects, the serial communication protocol can use two conductors, although the serial communication bus can include more conductors without departing from the scope of the present subject matter. At 303, if the device is in a serial mode of operation, the controller associated with the serial communication port can buffer the information as it is serially received, parse the buffered information into useable chucks, and process the chucks to carry out the instructions of the information. In certain aspects, the parsing and processing of the information can be dictated by the serial protocol employed for the serial communications. In certain examples, parsing the information can include extracting commands, addresses and data from the information and placing the extracted components in certain processing registers. In certain examples, parsing or processing may determine, for example, by evaluating an address in the information, that the information is not addressed to the present device or is addressed to additional devices.

At 305, if the device is in a binary mode of operation, the information can be encoded in the states of the conductors and the controller can respond to a state of at least one of the two conductors to change an operation of the controller. For example, as discussed above, a pulse of state of one conductor of the serial port can command the controller to do a first action and a pulse or state of another conductor of the serial port can command a second action. In certain aspects, the actions can include, but are not limited to, incrementing a counter, timer or parameter, enabling or disabling a circuit device such as a clock or other circuit, or combinations thereof. Actions not included are actions typically associated with serial communication protocols such as, but not limited to, data carrier detect (DCD), data terminal ready (DTR), data send ready (DSR), request to send (RTS), ready to receive (RTR), clear to send (CTS), etc. In certain aspects, the method can include transitioning from serial mode to binary mode, and transitioning from binary mode to serial mode, both of which are discussed above.

In systems using a high rate digital interface to transfer various types of data in real time, line coding can often be used to assist in clock and data recovery success for serial communications. For example, the Mobile Industry Processor Interface (MIPI) M-PHY¹ protocol can use 8b/10b line coding² on top of the user payload in order to guarantee a certain bit transition density and DC balance, and to provide successful CDR (Clock Data Recovery) and low bit error rate on the receiving end. The MIPI M-PHY layer is a performance-driven physical layer for multimedia and chip-to-chip inter-processor communication (IPC) applications. As an example, 8b/10b coding guarantees a run length (length of consecutive one or zero bits) of no more than 5 bits, and a max digital sum variation (max difference in value between the running sums of the data bits³) of five. This line coding, however, can increase the total data rate by 25%, so the M-PHY power that is proportional to data rate can also increases 25%. In 5G mmW, with raw I/Q data rates as high as 39 Gbps for an 800 MHz 2×2 MIMO configuration, the M-PHY power is projected to be around 20% of the transceiver power for high bandwidth use cases, so this line coding overhead can significant increase power consumption. For a given max bandwidth requirement, the M-PFIY overhead can also lead to additional M-PHY IP blocks being added, thus increasing die size and package I/O count. ¹ MIPI Alliance Specification for M-PHY, Version 4.1, 1 Dec. 2016² A. Widmer, P. Franaszek, “A DC-Balanced, Partitioned-Block, 8B/10B Transmission Code”, IBM Journal of Research & Development, September 1983³ Data bits 0 and 1 can be treated as −1 and +1 for a DSV summing calculation. A repeating data pattern such as 1110111011101110 . . . etc would not violate any rim length spec but can result in a high DSV (e.g., +8 for the bits shown), causing a DC offset in the output which can saturate the line receiver input if DC coupling is used.

Other forms of line coding such as have been implemented to reduce power consumption overhead compared to 8b/10b line coding. 64b/66b line coding format (3.1% overhead) has been adopted for Gbit Ethernet and Fibre Channel, and a 128/130 line coding scheme (1.5% overhead) is used for PCIe 3.0. The 64/66 format can use a scrambler to ensure no more than 64 bit run length even if a hacker tries to insert phony data.

Longer line coding schemes such as 64/66 can add a very large overhead for short data bursts of, say, 16 bits, in that filler data is typically inserted to make the data block 64 bits. Longer line coding schemes also only guarantee bit transitions within the encoded data block size. Thus, a system requiring bit transitions every 30 bits could use 8b/10b, but that is overkill leading to the 25% data overhead, while using the 64/66 line coding would not meet the transition density requirements. Also, a single bit error occurring in the data channel can propagate in the decoder, leading to multiple bit errors if CRC error protection is not applied to the payload. Additionally, complex line coding schemes like 8b/10b or 64b/66b add gate count and power consumption just due to the coding/decoding process.

The present inventors have recognized a hybrid form of line coding with less power consumption cost as 8b/10b, while also providing bit shift diversity to assist in clock and data recovery (CDR) at the receiver end of a communication path. Reduction of line coding overhead is important for reducing IC KPIs such as power consumption and pin count. Bit diversity can allow faster clock and data recovery and reduce the opportunity for saturation of the line receiver.

In certain aspects, a data block can be examined prior to transmission across the serial link. If an observed run length or digital sum variation (DSV) of the data exceeds a run threshold for the system, the data of the block can be intentionally modify to satisfy the Low Voltage Differential Signaling (LVDS) receiver's thresholds for max run length and DSV. In certain aspects, if a run threshold is exceeded, a bit of the data can intentionally be switched (e.g., from a 1 to 0, or vice versa.) In some aspects, an intentional bit can be changed that results in a very small value change of a piece of data. In some aspects, an intentional bit change can result in a polarity change of a piece of data. In certain aspects, a bit near the middle of a run of bits can be switched to effectively cut the run length in half. In some examples, a least significant bit (LSB) of a data word can he switched to change a value of a word by a small value. In some aspects, a LSB of a word in the middle of the run length can be switched to cut the run length in half and to modify the value of the data by a small, incremental amount. In certain examples, when data, such as I/Q data, violates a run threshold and a bit flip is determined as a remedy, a controller can flip one of the LSB bits of an I/Q data word having a large magnitude. Such a bit flip can have a negligible impact on the error vector magnitude (EV M) and, thus, little if any degradation of system performance.

In certain aspects, in addition to examining data block run length and DSV over large intervals of data, a controller can also monitor DSV over short intervals. In certain aspects, if a short duration DSV threshold is violated for a length of data, the controller can employ DSV mitigation such as adding or subtracting a small value from a word of the data to for example, change a length of 1's to mostly 0's or vice versa. For data that may need filler data or dummy data, the dummy data can be an alternating sequence of 0s and 1s (e.g., 01010101 . . . ) to produce maximum transition rate and a short-term DC of zero.

In certain aspects, where control data can flow with the payload data, or when other data types for which intentional bit errors can not be tolerated are transmitted, line coding can he enabled. In certain examples, line coding can be enabled when it is unclear what type of data is being processed in the system or when control or other data that can not tolerate intentional data modification, and can be disabled when payload data, such as I/Q data for mmW transceivers, is being processed. While line coding is enabled, LSB bit flipping and short term DSV mitigation techniques can be disable. Also, when line coding is enabled, LSB bit flipping and DSV mitigation techniques can be enabled.

An advantage to being able to disable line coding, as discussed above, is that overhead for communicating payload data, such as I/Q data blocks, is little, if any. In certain MIPI applications, a 20% reduction in the data rate for I/Q data can be realized. In certain MIPI applications, the aggregate M-PHY control traffic is much smaller than the data traffic . . . typically <5% for high bandwidth use cases. Thus, the total M-PHY traffic can be reduced by nearly 20%, which can reduce M-PHY-related power consumption by nearly 20%, and can reduce the required number of M-PHY lanes by around 20%. Therefore, in certain aspects, performance of an example M-PHY employing control according to the present subject matter can use 7 M-PHY lanes (28 conductors) and can match performance of a conventional M-PHY using 8 lanes (32 wires), thus saving four wires.

In addition, the present subject matter method for bounding run length can scaled and modified based on a maximum run length of the particular differential signaling architecture in use. In particular, when a M-PHY transmitter and receiver share a common reference clock, the allowable data run length can be much longer than if asynchronous reference clocks are used. Also, without line coding, data transmission errors do not propagate as they do when 8b/10b line coding is used. For example, the 8b/10b line coding scheme of the MIPI M-PHY standard can propagate a single TX bit error up to a length of five bits in the decoded domain. In certain aspects, a single bit error over the channel only corrupts that bit and no adjacent bits.

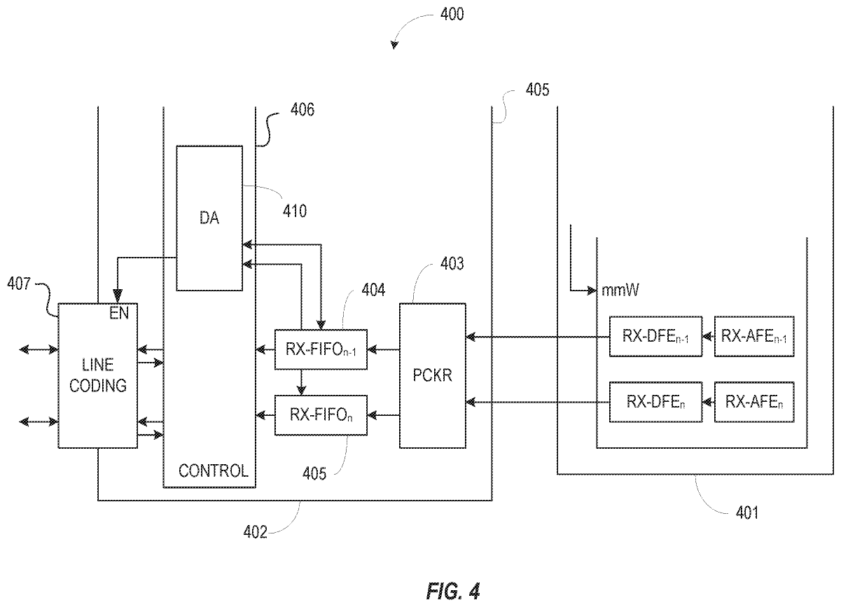

FIG. 4 illustrates generally an example circuit 400 employing a serial interface controller according various aspect of the present subject matter. The circuit can include a data source 401 such as a receiver or a wireless transceiver for user equipment (UE), a physical interface circuit 402, such as a serial interface circuit, having a serial port. In some aspects, the physical interface circuit 402 can be a part of the data source circuit 401. The physical interface circuit 402 can include a packer circuit 403, first-in, first-out buffers (FIFOs) 404, 405, the serial interface controller 406, and a line code circuit 407. The packer circuit 403 can receive first digital information from the data source 401 and route the first information to the FIFOs 404, 405. The FIFOs 404, 405 can buffer the first digital information into frames. Upon buffering a payload of digital information, the serial interface controller 406 can append a header to the frame, and the frame can be forwarded to the line code circuit 407 which can he part of the serial port in certain aspects. The line code circuit 407 can apply line coding to the frame and can transmit the frame to another circuit such as a baseband processor for example. In certain aspects, the serial interface controller 406 can add control characters to the header to indicate when line coding at the line code circuit 407 is to be enabled or disabled. In some examples, the serial interface controller 406 can have an output connected to an input (EN) of the line code circuit 407 to control enabling and disabling line coding at the line code circuit 407.

In certain aspects, the serial interface controller 406 can include a data analysis (DA) circuit 410 to examine the first digital data in each frame to determine if line coding can be disabled. For example, if the DA circuit determines that the first digital information in a FIFO 404, 405 is data that can tolerate intentional manipulation, the serial interface controller 406 can place control characters in the frame header, or change a state of an output coupled to an input (EN) of the line code circuit 407 when the frame is passed to the line code circuit 407. The control characters or state of the output can indicate that the line code circuit 407 should not line code the payload of the frame. In addition, prior to transferring the frame from the FIFO 404, 405, or during the addition of the header, the DA circuit can examine the payload of the frame for bit runs that exceed a bit run length threshold or short-term data runs that violate a DSV threshold that cause a DC offset in the output that may saturate a receiver input. In certain aspects, if a threshold has been violated, the DA circuit 410 can make a small incremental change, as discussed above, to the payload data to alleviate detrimental effects of violating a threshold or to assist in clock and data recovery at the device receiving the frame of information. Additionally, as discussed above, the small incremental change to the data payload will be done in such a manner so as to produce negligible degradation on the overall system performance.

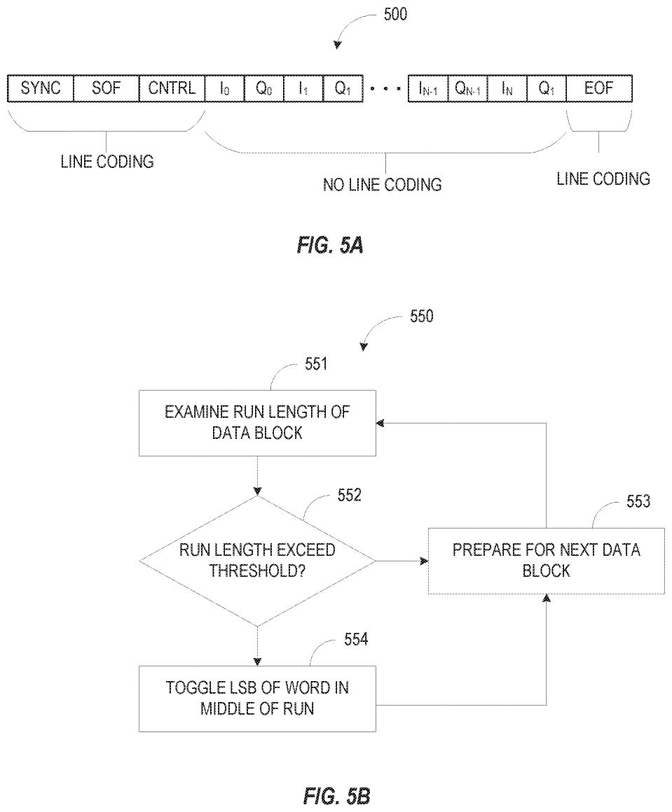

FIGS. 5A illustrates generally an example data frame 500 of information to be transmitted by a serial interface circuit, such the serial interface circuit 402 of FIG. 4, according to various aspects of the present subject matter. FIG. 5B illustrates generally a flowchart of an example method 550 associated with processing the data frame 500 of FIG. 5A according to various aspects of the present subject matter. The data frame 500 can include header information defined by the communication protocol being used or by a manufacturer of the circuit using the physical interface circuit. Such header information can include, but is not limited to, one or more of synchronization information (SYNC) such as that defined by the MIPI standard, start of frame (SOF) marker information, control information (CNTRL) for the protocol or for the physical interface, and an end of frame marker (EOF) information. The remainder of the frame can include payload information (e.g., Iₓ, Qₓ). In certain examples, the payload information can include, but is not limited to, coordinate symbols for wireless communication (e.g., Cartesian (I/Q) information, polar coordinate information), audio data, display data, or other data that can tolerate intentional manipulation. In the example of FIGS. 5A and 5B, the payload information can include M word pairs of I/Q information and is assumed to have accumulated in a FIFO of, for example, the circuit of FIG. 4. At 551, the accumulated date is evaluated for bit runs per word pair starting with a first word pair. At 552, bit run lengths of the word pair are compared to a maximum run length threshold. At 553, if a bit run length of the word pair does not violate the maximum run threshold, a pointer can be incremented to the next word pair for evaluation. At 554, if a bit run length of the word pair does violate the maximum run threshold, a least significant bit (LSB) of a word or byte in the middle of the run can be switched and the method 550, at 553, can increment a pointer to prepare for the next word pair block of data.

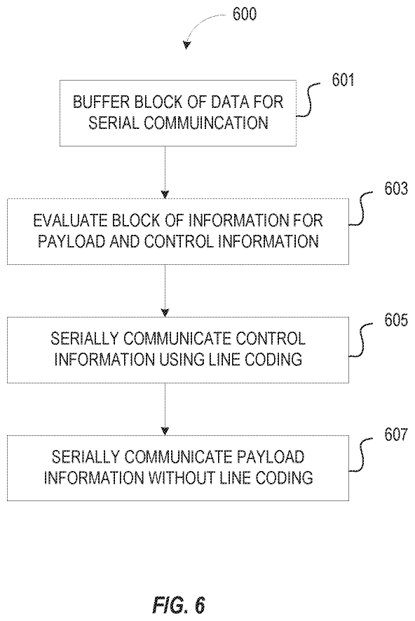

FIG. 6 illustrates generally a flowchart of an example method 600 of controlling a serial communication interface to reduce line coding overhead. At 601, a block of information can be buffered. In certain aspects the block of information can be received from a different circuit. In some aspects, the block of information can be buffered in a FIFO. At 603, the block of data can be evaluated to locate and distinguish payload information of the block of information from control information of the block of information, to locate the control information, to append control information to the block of information in the form of a header or footer for example, or combinations thereof. At 605, control information of the block of information can be serially transmitted from a first serial interface to a second serial interface using a predetermined line coding scheme. At 607, payload information of the block of information can be serially transmitted from the first serial interface to the second serial interface without using line coding. In certain aspects, line coding can be enabled and disabled using a controller of the first serial interface. In certain aspects, the method of FIG. 5B can be combined with the method of FIG. 6 to reduce serial communication throughput via reduced overhead associated. with line coding the payload information, and can assist clock and data recovery at a receiving serial interface by ensuring bit transition diversity via reduced bit runs, or runs of consecutive bits having the same bit value.

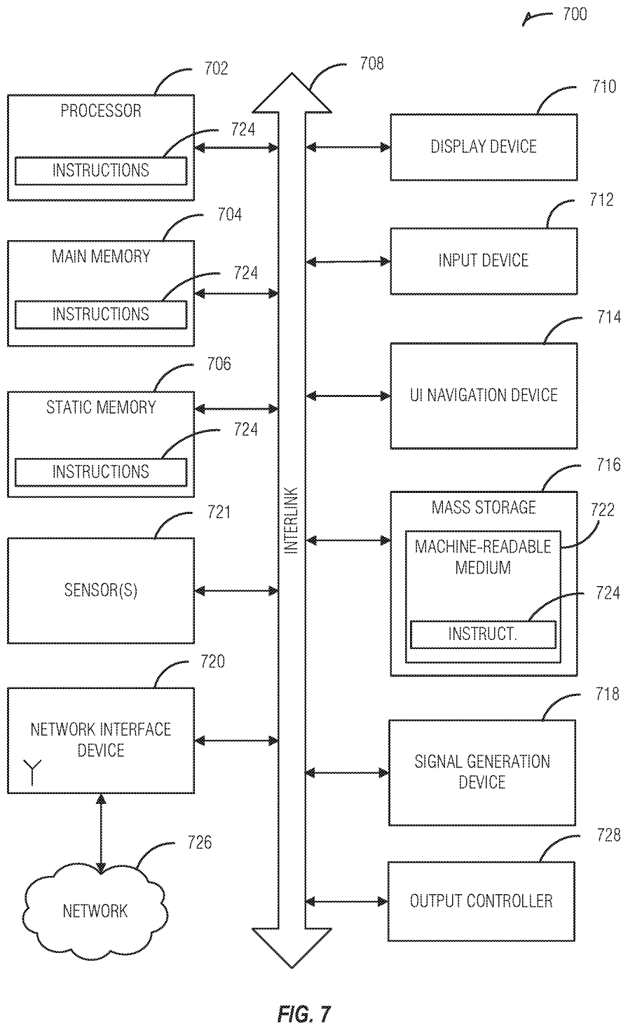

FIG. 7 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (or other distributed) network environment. As used herein, peer-to-peer refers to a data link directly between two devices (e.g., it is not a hub-and spoke topology). Accordingly, peer-to-peer networking is networking to a set of machines using peer-to-peer data links. The machine 700 may be a single-board computer, an integrated circuit package, a system-on-a-chip (SOC), a personal computer (PC), a tablet PC, a set-top box (STB), a personal digital assistant (PDA), a mobile telephone, a web appliance, a network router, or other machine capable of executing instructions (sequential or otherwise) that specify actions to be taken by that machine. Further, while only a single machine is illustrated, the term “machine” shall also he taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation, Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In certain examples, any one or more of the display unit 710, storage device 716, network interface device or combination thereof can include a multiple device PCIe card.

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted. or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

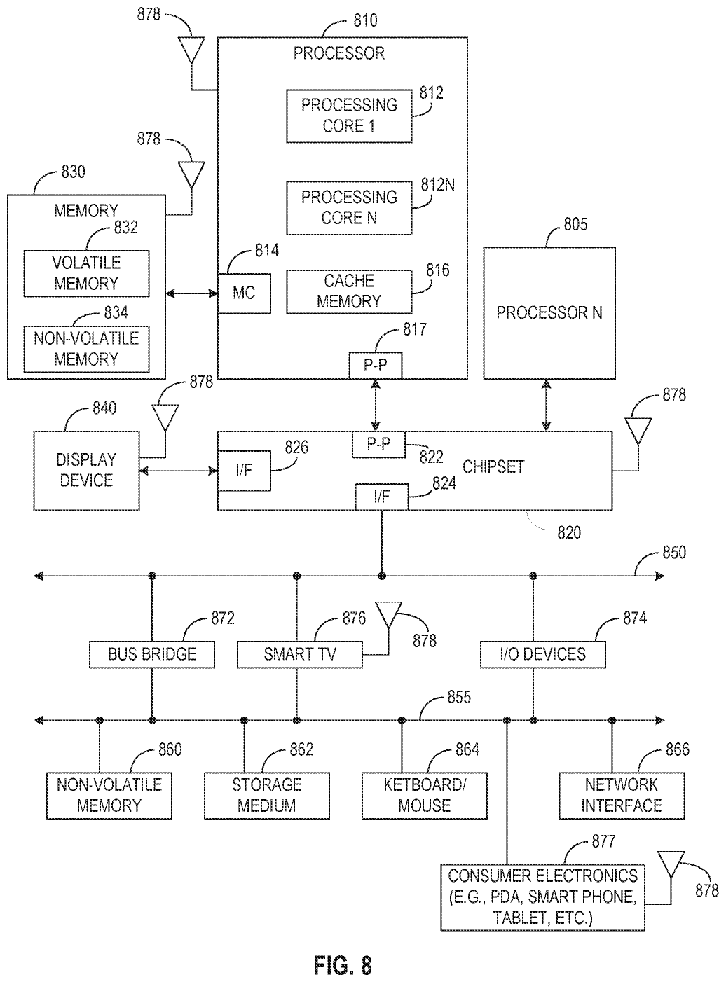

FIG. 8 illustrates a system level diagram, depicting an example of an electronic device (e.g., system) including a PCIe card as described in the present disclosure. FIG. 8 is included to show an example of a higher level device application that can use serial interfaces, such as those discussed above, exchange data between the illustrated components. In one embodiment, system 800 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In some embodiments, system 800 is a system on a chip (SOC) system.

In one embodiment, processor 810 has one or more processor cores 812 and 812N, where 812N represents the Nth processor core inside processor 810 where N is a positive integer. In one embodiment, system 800 includes multiple processors including 810 and 805, where processor 805 has logic similar or identical to the logic of processor 810. In some embodiments, processing core 812 includes, but is not limited to, pre-fetch logic to fetch instructions, decode logic to decode the instructions, execution logic to execute instructions and the like. In some embodiments, processor 810 has a cache memory 816 to cache instructions and/or data for system 800. Cache memory 816 may be organized into a hierarchal structure including one or more levels of cache memory.

In some embodiments, processor 810 includes a memory controller 814, which is operable to perform functions that enable the processor 810 to access and communicate with memory 830 that includes a volatile memory 832 and/or a non-volatile memory 834. In some embodiments, processor 810 is coupled with memory 830 and chipset 820. Processor 810 may also be coupled to a wireless antenna 878 to communicate with any device configured to transmit and/or receive wireless signals. In one embodiment, an interface for wireless antenna 878 operates in accordance with, but is not limited to, the IEEE 802.11 standard and its related family, Home Plug AV (HPAV), Ultra Wide Band (UWB), Bluetooth, WiMax, or any form of wireless communication protocol.

In some embodiments, volatile memory 832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 834 includes, but is not limited to, flash memory, phase change memory (PCM), read-only memory (ROM), electrically erasable programmable read-only memory (EEPROM), or any other type of non-volatile memory device.

Memory 830 stores information and instructions to be executed by processor 810, In one embodiment, memory 830 may also store temporary variables or other intermediate information while processor 810 is executing instructions. In the illustrated embodiment, chipset 820 connects with processor 810 via Point-to-Point (PtP or P-P) interfaces 817 and 822. Chipset 820 enables processor 810 to connect to other elements in system 800, In some embodiments of the example system, interfaces 817 and 822 operate in accordance with a PtP communication protocol such as the Intel® QuickPath Interconnect (QPI) or the like. In other embodiments, a different interconnect may be used.

In some embodiments, chipset 820 is operable to communicate with processor 810, 805N, display device 840, and other devices, including a bus bridge 872, a smart TV 876, I/O devices 874, nonvolatile memory 860, a storage medium (such as one or more mass storage devices) 862, a keyboard/mouse 864, a network interface 866, and various forms of consumer electronics 877 (such as a PDA, smart phone, tablet etc.), etc. In one embodiment, chipset 820 couples with these devices through an interface 824. Chipset 820 may also be coupled to a wireless antenna 878 to communicate with any device configured to transmit and/or receive wireless signals.

Chipset 820 connects to display device 840 via interface 826. Display 840 may be, for example, a liquid crystal display (LCD), a plasma display, cathode ray tube (CRT) display, or any other form of visual display device. In some embodiments of the example system, processor 810 and chipset 820 are merged into a single SOC. In addition, chipset 820 connects to one or more buses 850 and 855 that interconnect various system elements, such as I/O devices 874, nonvolatile memory 860, storage medium 862, a keyboard/mouse 864, and network interface 866. Buses 850 and 855 may be interconnected together via a bus bridge 872.

In one embodiment, mass storage device 862 includes, but is not limited to, a solid state drive, a hard disk drive, a universal serial bus flash memory drive, or any other form of computer data storage medium. In one embodiment, network interface 866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family. Home Plug AV (HPAV), Ultra Wide Band (UWB), Bluetooth, WiMax, or any form of wireless communication protocol.

While the modules shown in FIG. 8 are depicted as separate blocks within the system 800, the functions performed by some of these blocks may be integrated within a single semiconductor circuit or may be implemented using two or more separate integrated circuits. For example, although cache memory 816 is depicted as a separate block within processor 810, cache memory 816 (or selected aspects of 816) can he incorporated into processor core 812.

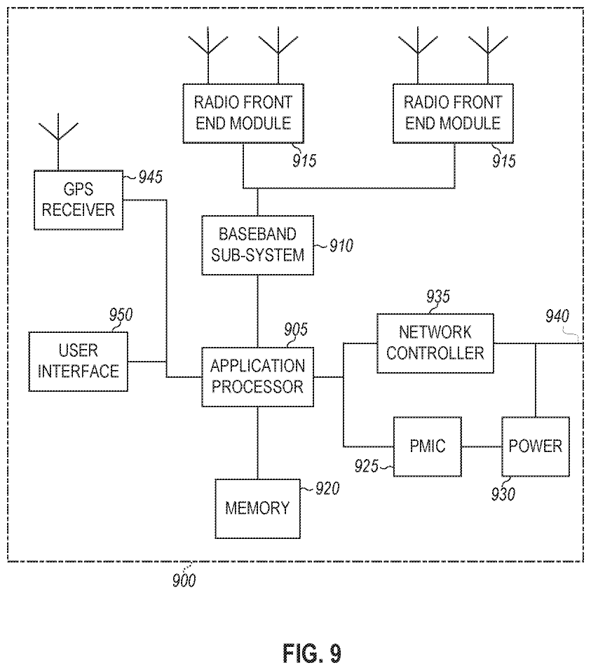

FIG. 9 illustrates an exemplary base station or infrastructure equipment radio head according to some aspects. The base station radio head 900 may include one or more of application processor 905, baseband processors 910, one or more radio front end modules 915, memory 920, power management integrated circuitry (PMIC) 925, power tee circuitry 930, network controller 935, network interface connector 940, satellite navigation receiver (e.g., GPS receiver) 945, and user interface 950.

In some aspects, application processor 905 may include one or more CPU cores and one or more of cache memory, low drop-out voltage regulators (LDOs), interrupt controllers, serial interfaces such as SPI, I2C or universal programmable serial interface, real time clock (RTC), timer-counters including interval and watchdog timers, general purpose IO, memory card controllers such as SD/MMC or similar, USB interfaces, MIPI interfaces and Joint Test Access Group (JTAG) test access ports.

In some aspects, baseband processor 910 may be implemented, for example, as a solder-down substrate including one or more integrated circuits, a single packaged integrated circuit soldered to a main circuit board or a multi-chip sub-system including two or more integrated circuits.

In some aspects, memory 920 may include one or more of volatile memory including dynamic random access memory (DRAM) and/or synchronous DRAM (SDRAM), and nonvolatile memory (NVM) including high-speed electrically erasable memory (commonly referred to as Flash memory), phase-change random access memory (PRAM), magnetoresistive random access memory (MRAM), and/or a three-dimensional crosspoint memory. Memory 920 may be implemented as one or more of solder down packaged integrated circuits, socketed memory modules and plug-in memory cards.

In some aspects, power management integrated circuitry 925 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 930 may provide for electrical power drawn from a network cable. Power tee circuitry 930 may provide both power supply and data connectivity to the base station radio head 900 using a single cable.

In some aspects, network controller 935 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver 945 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The receiver 945 may provide, to application processor 905, data which may include one or more of position data or time data. Time data may be used by application processor 905 to synchronize operations with other radio base stations or infrastructure equipment.

In some aspects, user interface 950 may include one or more of buttons. The buttons may include a reset button. User interface 950 may also include one or more indicators such as LEDs and a display screen.

### Additional Notes

In a first aspect, Aspect 1, a method can include receiving information via an input serial communication port of a control circuit, the input serial communication port having at least two conductors, in a serial mode of the control circuit, buffering the information as the information is received, parsing the information according to a serial protocol, and processing the information according to the serial protocol, and, in a binary mode of the control circuit, conforming an operation of the control circuit in response to a state of at least one of the two conductors.

In Aspect 2, the conforming an operation of the control circuit of Aspect 1 optionally includes changing a parameter of the control circuit in response to a pulse received on a first conductor of the at least two conductors.

In Aspect 3, the changing the parameter of any one or more of Aspects 1-2 optionally includes changing the parameter by an increment, wherein a value of the increment is based on a width of the pulse.

In Aspect 4, the method of any one or more of Aspects 1-3 optionally includes transitioning from the binary mode of the control circuit to the serial mode of the control circuit in response to simultaneously receiving a first pulse on a first conductor of the at least two conductors and a second pulse on a second conductor of the at least two conductors.

In Aspect 5, the method of any one or more of Aspects 1-4 optionally includes transitioning from the serial mode to the binary mode in response to a change in value of a memory location readable by the control circuit.

In Aspect 6, the method of any one or more of Aspects 1-5 optionally includes, in the serial mode, passing first information configured to change the value of the memory location.

In Aspect 7, the method of any one or more of Aspects 1-6 optionally includes, in the serial mode, passing information received at the input serial communication port to a down-stream device via a serial bus coupled to the control circuit, and, in the binary mode, not passing information received at the input serial communication port to the down-stream device.

In Aspect 8, the method of any one or more of Aspects 1-7 optionally includes, in the serial mode, passing the information along to an output serial communication port of the control circuit, the output serial communication port having at least two conductors.

In Aspect 9, a circuit can include processing logic including a serial interface circuit, and a peripheral circuit coupled with the processing logic. The processing logic can be configured to receive information via the serial interface circuit from a serial bus, the serial bus having at least two conductors, in a first mode, the processing logic can be configured to buffer, parse and process the information, and, in a second mode, the processing logic can be configured to change a state of operation of the peripheral circuit in response to a state of at least one of the two conductors of the serial bus.

In Aspect 10, the peripheral circuit of any one or more of Aspects 1-9 optionally includes a voltage regulator.

In Aspect 11, the peripheral circuit of any one or more of Aspects 1-10, in the second mode and in response to a. first state of a first conductor of the serial bus, optionally is configured to command a voltage output increase of the voltage regulator.

In Aspect 12, the peripheral circuit of any one or more of Aspects 1-11, in the second mode and in response to a first state of a second conductor of the serial bus, optionally is configured to command a voltage output decrease of the voltage regulator.

In Aspect 13, the processing logic of any one or more of Aspects 1-12, in the second mode and in response to a first conductor of the serial bus and a second conductor of the serial bus both having a first state, optionally is configured to transition the processing logic to the first mode.

In Aspect 14, the circuit of any one or more of Aspects 1-13 optionally includes a memory, the processing logic, in the first mode, optionally is configured to change a memory location of the memory from a third state to a fourth state in response to a parsed command of the information, and the processing logic and the peripheral circuit are optionally configured to transition from the first mode to the second mode in response to the change of the memory location from the third state to the fourth state.

In Aspect 15, the processing logic of any one or more of Aspects 1-14, in the second mode and in response to a first conductor of the serial bus and a second conductor of the serial bus both having a first state, optionally is configured to change the memory location from the fourth state to the third state.

In Aspect 16, the processing logic and the peripheral circuit of any one or more of Aspects 1-15 optionally are configured to transition from the second mode to the first mode in response to the change of the memory location from the fourth state to the third state.

In Aspect 17, the peripheral circuit of any one or more of Aspects 1-16 optionally includes a parameter, the peripheral circuit, in the second mode and in response to a first state of a first conductor of the serial bus, optionally is configured to increase a value of the parameter, and the peripheral circuit, in the second mode and in response to a first state of a second conductor of the serial bus, optionally is configured to decrease a value of the parameter.

In Aspect 18, the parameter of any one or more of Aspects 1-17 optionally is a voltage seipoint of a voltage regulator.

In Aspect 19, the parameter of any one or more of Aspects 1-18 optionally is a count value of a counter circuit.

In Aspect 20, the parameter of any one or more of Aspects 1-19 optionally is a tinier preset value of a tinier circuit.

In Aspect 21, a width of a pulse in the first state of either the first conductor or the second conductor of any one or more of Aspects 1-20 optionally determines a magnitude of change of the value of the parameter.

In Aspect 22, a method for operating a serial interface can include buffering a block of information at a first serial interface to provide a buffered block of information, determining payload information and control information of the block of information, transferring the control information from the first serial interface to a second serial interface using a predetermined line coding protocol, and transferring the payload information from the first serial interface to the second serial interface without using line coding.

In Aspect 23, the transferring the control information of any one or more of Aspects 1-22 optionally includes enabling a line coding function of the first serial interface.

In Aspect 24, the transferring the payload information of any one or more of Aspects 1-23 optionally includes disabling the line coding function of the first serial interface.

In Aspect 25, the transferring the payload information of any one or more of Aspects 1-24 optionally includes disabling a line coding function of the first serial interface before serially transmitting a first portion of the payload information, and enabling the line coding function of the first serial interface after serially transferring a last portion of the payload information.

In Aspect 26, the method of any one or more of Aspects 1-25 optionally includes evaluating the payload information of the buffered block of information against one or more thresholds, and modifying the payload information when a block of the payload information violates a threshold of the one or more thresholds.

In Aspect 27, the modifying the payload information of any one or more of Aspects 1-26 optionally includes changing one or more bits of the block when a bit run length of the block violates a bit run length threshold.

In Aspect 28, the one or more bits of any one or more of Aspects 1-27 optionally are located in a middle portion of the bit run length that violates the bit run length threshold.

In Aspect 29. wherein the one or more bits of any one or more of Aspects 1-28 optionally are least significant bits of a word in the middle portion.

In Aspect 30, the modifying the payload information of any one or more of Aspects 1-29 optionally includes adding a value to a word of the block when a digital sum variation (DSV) of the block violates a DSV threshold.

In Aspect 31, the word of any one or more of Aspects 1-30 optionally includes bits within a middle of a bit run that violates the DSV threshold.

In Aspect 32, the value of any one or more of Aspects 1-31 optionally is 1.

In Aspect 33, the value of any one or more of Aspects 1-32 optionally is −1.

In Aspect 34, the modifying the payload information of any one or more of Aspects 1-33 optionally includes subtracting a value from a word of the block when a digital sum variation (DSV) of the block violates a DSV threshold.

In Aspect 35, the word of any one or more of Aspects 1-34 optionally includes bits within a middle of a bit run that violates the DSV threshold.

In Aspect 36, the payload information of any one or more of Aspects 1-35 optionally includes audio information.

In Aspect 37, the payload information of any one or more of Aspects 1-34 optionally includes cartesian trajectory information of a modulated signal.

in Aspect 38, the payload information of any one or more of Aspects 1-37 optionally is polar coordinate information of a modulated signal.

In Aspect 39, a system can include a buffer configured to buffer a block of information received at a first serial interface and to provide a buffered block of information, and a serial interface controller configured determine payload information and control information of the buffered block of information, to transfer the control information from a first serial interface to a second serial interface using a predetermined line coding protocol, and to transfer the payload information from the first serial interface to the second serial interface without using line coding.

In Aspect 40, the system of any one or more of Aspects 1-39 optionally includes user equipment having a wireless transceiver, and the buffer optionally is configured to receive the block of information from the wireless transceiver.

In Aspect 41, the system of any one or more of Aspects 1-40 optionally includes a baseband processor, and the baseband processor optionally includes the second serial interface.

In Aspect 42, the buffer of any one or more of Aspects 1-41 optionally is a first in, first out (FIFO) buffer.

In Aspect 43, the payload information of any one or more of Aspects 1-42 optionally includes cartesian trajectory information of a modulated signal of the wireless transceiver.

In Aspect 44, the payload information of any one or more of Aspects 1-43 optionally includes polar coordinate information of a modulated signal of the wireless transceiver.

In Aspect 45, the system of any one or more of Aspects 1-44 optionally includes an audio transducer; and the payload information optionally includes audio information.

In Aspect 46, the system of any one or more of Aspects 1-2 optionally includes a display, and the payload information optionally includes display information for presentation on the display.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are legally entitled.

1. A method comprising:
receiving information via an input serial communication port of a control circuit, the input serial communication port having at least two conductors;
in a serial mode of the control circuit, buffering the information as the information is received, parsing the information according to a serial protocol, and processing the information according to the serial protocol; and
in a binary mode of the control circuit, conforming an operation of the control circuit in response to a state of at least one of the two conductors.

2. The method of claim 1, wherein the conforming an operation of the control circuit includes changing a parameter of the control circuit in response to a pulse received on a first conductor of the at least two conductors.

3. The method of claim 2, wherein changing the parameter includes changing the parameter by an increment, wherein a value of the increment is based on a width of the pulse.

4. The method of claim 1, including transitioning from the binary mode of the control circuit to the serial mode of the control circuit in response to simultaneously receiving a first pulse on a first conductor of the at least two conductors and a second pulse on a second conductor of the at least two conductors.

5. The method of claim 1, including transitioning from the serial mode to the binary mode in response to a change in value of a memory location readable by the control circuit.

6. The method of claim 7, including, in the serial mode, passing first information configured to change the value of the memory location.

7. The method of claim 1, including, in the serial mode, passing information received at the input serial communication port to a down-stream device via a serial bus coupled to the control circuit; and
in the binary mode, not passing information received at the input serial communication port to the down-stream device.

8. The method of claim 1, including, in the serial mode, passing the information along to an output serial communication port of the control circuit, the output serial communication port having at least two conductors.

9. A circuit comprising:
processing logic including a serial interface circuit; and
a peripheral circuit coupled with the processing logic;
wherein the processing logic is configured to receive information via the serial interface circuit from a serial bus, the serial bus having at least two conductors;
wherein, in a first mode, the processing logic is configured to buffer, parse and process the information; and
wherein, in a second mode, the processing logic is configured to change a state of operation of the peripheral circuit in response to a state of at least one of the two conductors of the serial bus.

10. The circuit of claim 9, wherein the peripheral circuit includes a voltage regulator.

11. The circuit of claim 10, wherein the peripheral circuit, in the second mode and in response to a first state of a first conductor of the serial bus, is configured to command a voltage output increase of the voltage regulator.

12. The circuit of claim 11, wherein the peripheral circuit, in the second mode and in response to a first state of a second conductor of the serial bus, is configured to command a voltage output decrease of the voltage regulator.

13. The circuit of claim 9, wherein the processing logic, in the second mode and in response to a first conductor of the serial bus and a second conductor of the serial bus both having a first state, is configured to transition the processing logic to the first mode.

14. The circuit of claim 9, including a memory; and
wherein the processing logic, in the first mode, is configured to change a memory location of the memory from a third state to a fourth state in response to a parsed command of the information; and
wherein the processing logic and the peripheral circuit are configured to transition from the first mode to the second mode in response to the change of the memory location from the third state to the fourth state.

15. The circuit of claim 14, wherein the processing logic, in the second mode and in response to a first conductor of the serial bus and a second conductor of the serial bus both having a first state, is configured to change the memory location from the fourth state to the third state.

16. The circuit of claim 15, wherein the processing logic and the peripheral circuit are configured to transition from the second mode to the first mode in response to the change of the memory location from the fourth state to the third state.

17. The circuit of claim 9, wherein the peripheral circuit includes a parameter;
wherein the peripheral circuit, in the second mode and in response to a first state of a first conductor of the serial bus, is configured to increase a value of the parameter; and
wherein the peripheral circuit, in the second mode and in response to a first state of a second conductor of the serial bus, is configured to decrease a value of the parameter.

18. The circuit of claim 17, wherein the parameter is a voltage setpoint of a voltage regulator.

19. The circuit of claim 17, wherein the parameter is a count value of a counter circuit.

20. The circuit of claim 17, wherein the parameter is a timer preset value of a timer circuit.

21. The circuit of claim 17, wherein a width of a pulse in the first state of either the first conductor or the second conductor determines a magnitude of change of the value of the parameter.

22-46. (canceled)
